(19) United States
(12) Patent Application Publication
(10) Pub. No.: US 2009/0158100 A1
(43) Pub. Date: Jun. 18, 2009

(54) JITTER APPLYING CIRCUIT AND TEST APPARATUS

(75) Inventors: ATSUO SAWARA, TOKYO (JP); YUICHI MIYAJI, TOKYO (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANTEST CORPORATION, TOKYO (JP)

(21) Appl. No.: 11/955,391

(22) Filed: Dec. 13, 2007

(51) Int. Cl. G06F 11/07

(52) U.S. Cl. 714/700; 714/E11.023

(57) ABSTRACT

There is provided a jitter applying circuit that includes: a signal transmission path that transmits a signal from an input end to an output end thereof; a jitter control section that outputs, from an output terminal thereof, a jitter control voltage that is in accordance with jitter to be superposed to a signal propagating on the signal transmission path; a buffer circuit that is serially connected between the input end and the connection point on the signal transmission path; a serial resistance that is serially connected between the buffer circuit and the connection point, on the signal transmission path; and a variable capacitance diode that is provided between a connection point on the signal transmission path and the output terminal of the jitter control section, and whose capacitance changes in accordance with the jitter control voltage.

### BACKGROUND

1. Technical Field

The present invention relates to a jitter applying circuit and a test apparatus. In particular, the present invention relates to a jitter applying circuit that applies jitter to a signal to be transmitted, and to a test apparatus that tests a device under test.

2. Related Art

A test apparatus that tests a jitter resistance of a device under test includes a jitter applying circuit that applies jitter to a test signal. As one example, the jitter applying circuit includes a variable delay circuit whose delay amount fluctuates according to jitter to be given, and applies jitter to the test signal by passing the test signal through the variable delay circuit (please refer to the Patent Reference 1 for example). In addition, the jitter applying circuit includes a PLL circuit that outputs a clock signal, and applies jitter to a clock signal by adding jitter to a phase error of the PLL circuit (please refer to the Patent Reference 2 for example).

A jitter applying circuit that includes a conventional variable delay circuit and a jitter delay circuit that includes a PLL circuit both have a complicated structure.
Patent Reference 1: Japanese Patent Application Publication No. H5-235718
Patent Reference 2: Japanese Patent Application Publication No. 2006-41640

### SUMMARY

Therefore, it is an object of an aspect of the innovations herein to provide a jitter applying circuit and a test apparatus which are capable of overcoming the above drawbacks accompanying the related art. The above and other objects can be achieved by combinations described in the independent claims. The dependent claims define further advantageous and exemplary combinations of the innovations herein.

According to the first aspect related to the innovations herein, one exemplary jitter applying circuit includes: a signal transmission path that transmits a signal from an input end to an output end thereof; a jitter control section that outputs, from an output terminal thereof, a jitter control voltage that is in accordance with jitter to be superposed to a signal propagating on the signal transmission path; and a variable capacitance diode that is provided between a connection point on the signal transmission path and the output terminal of the jitter control section, and whose capacitance changes in accordance with the jitter control voltage.

According to the second aspect related to the innovations herein, one exemplary test apparatus for testing a device under test includes: a pattern generator that generates a test pattern for testing the device under test; a jitter applying circuit that applies jitter to the test pattern; and a signal supply section that supplies a test signal that is in accordance with the test pattern to which the jitter has been applied, to the device under test, where the jitter applying circuit includes: a signal transmission path that transmits, from an input end to an output end thereof, the test pattern received from the pattern generator; a jitter control section that outputs, from an output terminal thereof, a jitter control voltage that is in accordance with jitter to be superposed to the test pattern propagating on the signal transmission path; and a variable capacitance diode that is provided between a connection point on the signal transmission path and the output terminal of the jitter control section, and whose capacitance changes in accordance with the jitter control voltage.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a configuration of a test apparatus 10 together with a device under test 200.

FIG. 2 shows a configuration of a jitter applying circuit 20 together with a driver circuit 28 that is one example of a signal supply section 22.

FIG. 3 shows one example of a signal before passing the jitter applying circuit 20 and a signal after passing the jitter applying circuit 20.

FIG. 4 shows one example of a waveform of a signal having passed the jitter applying circuit 20.

FIG. 5 shows a configuration of a jitter applying circuit 20 according to a first modification example of the present embodiment.

FIG. 6 shows a configuration of a jitter applying circuit 20 according to a second modification example of the present embodiment.

FIG. 7 shows a configuration of a jitter applying circuit 20 according to a third modification example of the present embodiment.

FIG. 8 shows a configuration of a jitter applying circuit 20 according to a fourth modification example of the present embodiment.

FIG. 9 shows a configuration of a test apparatus 10 according to a fifth modification example of the present embodiment.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

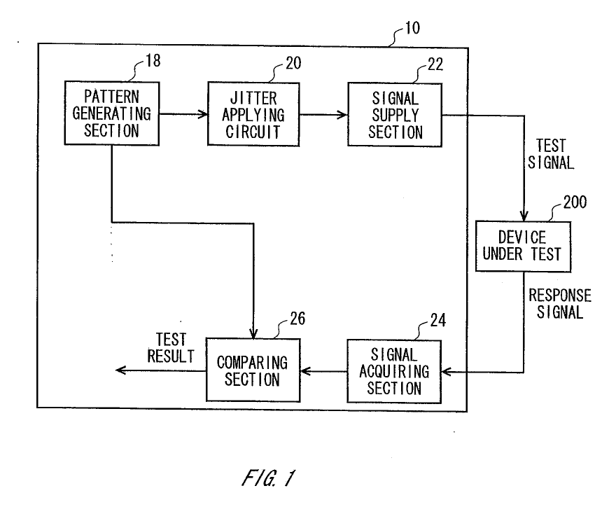

FIG. 1 shows a configuration of a test apparatus 10 together with a device under test 200. The test apparatus 10 tests the device under test 200. The test apparatus 10 includes a pattern generator 18, a jitter applying circuit 20, a signal supply section 22, a signal acquiring section 24, and a comparing section 26.

The pattern generator 18 generates a test pattern for testing the device under test 200. As an example, the pattern generator 18 may output, as a test pattern, a signal that becomes an H logic voltage (VDD) when representing the H logic, and that becomes an L logic voltage (VSS) when representing the L logic. Furthermore, the pattern generator 18 generates an expected value of a signal outputted from the device under test 200.

The jitter applying circuit 20 applies jitter to the test pattern generated by the pattern generator 18. The jitter applying circuit 20 may, as an example, apply jitter to a data signal outputted form the pattern generator 18, or apply jitter to a clock signal outputted from the pattern generator 18. In addition, the jitter applying circuit 20 may, as an example, apply jitter to a reference clock supplied to the pattern generator 18.

The signal supply section 22 supplies a test signal that is in accordance with the test pattern to which the jitter has been applied by the jitter applying circuit 20, to the device under test 200. The signal supply section 22 may be a driver circuit as an example.

The signal acquiring section 24 acquires a response signal outputted from the device under test 200 according to a supplied test signal. The signal acquiring section 24 may include, as an example, a level comparator circuit for converting the response signal into a logic level, and a timing comparator circuit for acquiring the logic of the response signal at a timing of a strobe signal designated by a test program or the like.

The comparing section 26 compares the logic of the response signal acquired by the signal acquiring section 24, to the expected value supplied from the pattern generator 18. Then the comparing section 26 outputs the result of comparing the logic of the response signal to the expected value. The test apparatus 10 stated above is able to output, to the device under test 200, the test signal to which jitter has been applied, to test the device under test 200.

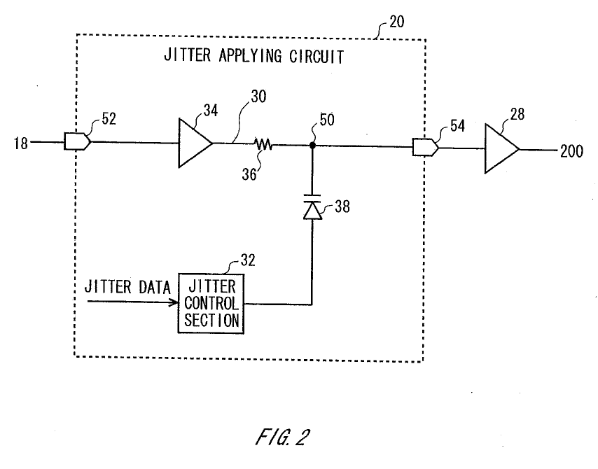

FIG. 2 shows a configuration of a jitter applying circuit 20 together with a driver circuit 28 that is one example of a signal supply section 22. The jitter applying circuit 20 includes a signal transmission path 30, a jitter control section 32, a buffer circuit 34, a serial resistance 36, and a variable capacitance diode 38.

The jitter applying circuit 20 receives a test pattern outputted from the pattern generator 18 via an input end 52 as a signal to which jitter is to be applied, and applies jitter to the received signal. Then the jitter applying circuit 20 supplies the signal to which the jitter has been applied, to the driver circuit 28 via the output end 54.

The driver circuit 28 outputs the H logic voltage (e.g. VDD) when the voltage of the supplied signal is larger than or equal to a threshold voltage V_{TH}. In addition, the driver circuit 28 outputs the L logic voltage (e.g. VSS) when the voltage of the supplied signal is smaller than the threshold voltage V_{TH}.

The signal transmission path 30 transmits a signal from the input end 52 to the output end 54. The signal transmission path 30 includes a connection point 50 between the input end 52 and the output end 54.

The jitter control section 32 outputs, from an output terminal thereof, a jitter control voltage that is in accordance with jitter to be superposed to a signal propagating on the signal transmission path 30. As an example, the jitter control section 32 may be supplied with jitter data representing jitter to be applied, and output a jitter control voltage resulting from performing DA conversion to the supplied jitter data. As an example, the jitter control section 32 may generate a jitter control voltage representing periodic jitter fluctuating according to a periodic signal such as a sine wave. Moreover, as an example, the jitter control section 32 may generate a jitter control voltage representing data dependent jitter, by changing the voltage according to a test pattern.

The buffer circuit 34 is serially connected between the input end 52 and the connection point 50 on the signal transmission path 30. That is, the buffer circuit 34 receives a signal inputted via the input end 52.

Then the buffer circuit 34 outputs a voltage corresponding to the logic of the received signal. As an example, the buffer circuit 34 outputs the H logic voltage when the voltage of the received signal is larger than or equal to the threshold voltage V_{TH}. In addition, the driver circuit 28 outputs the L logic voltage when the voltage of the received signal is smaller than the threshold voltage V_{TH}. As one alternative example, the buffer circuit 34 may output the H logic voltage when the voltage of the received signal is larger than or equal to the H-side threshold voltage V_{TH}, and output the L logic voltage when the voltage of the received signal is smaller than the L-side threshold voltage V_{TL} (where V_{TL}<V_{TH}). Even when the edge of the supplied signal is blunt, the buffer circuit 34 stated above is able to convert the supplied signal into a signal having a sharp edge, without changing (e.g. without delaying) a logic switching time at which the logic is switched (i.e. the time at which the signal becomes the threshold voltage V_{TH}).

The serial resistance 36 is serially connected between the buffer circuit 34 and the connection point 50 on the signal transmission path 30. That is, one end of the serial resistance 36 is connected to the output terminal of the buffer circuit 34, and the other end of the serial resistance 36 is connected to the connection point 50.

The variable capacitance diode 38 is provided between the connection point 50 on the transmission path 30 and the output terminal of the jitter control section 32. The capacitance of the variable capacitance diode 38 changes according to a jitter control voltage outputted by the jitter control section 32. As an example, the variable capacitance diode 38 may be a varicap diode whose capacitance changes according to a reverse voltage (i.e. a voltage whose cathode side is higher than its anode side). The serial resistance 36 and the variable capacitance diode 38 stated above are able to generate a voltage having undergone low pass filtering after outputted from the buffer circuit 34, at the connection point 50.

The buffer circuit 34, the serial resistance 36, and the variable capacitance diode 38 stated above function as a variable delay circuit for delaying a logic switching time of a supplied signal (i.e. a time at which the signal becomes the threshold voltage V_{TH}). In addition, the delay amount of the signal delayed by the buffer circuit 34, the serial resistance 36, and the variable capacitance diode 38 changes according to the capacitance of the variable capacitance diode 38. The capacitance of the variable capacitance diode 38 changes according to a jitter control voltage supplied by the jitter control section 32. Accordingly, the delay amount of the signal delayed by the buffer circuit 34, the serial resistance 36, and the variable capacitance diode 38 changes according to the jitter control voltage supplied by the jitter control section 32.

As an example, the anode of the variable capacitance diode 38 may be connected towards the output terminal of the jitter control section 32, and the cathode of the variable capacitance diode 38 may be connected towards the connection point 50. In this case, the jitter control section 32 outputs a jitter control voltage in the range lower than the lowest voltage (the lower one of the H logic voltage and the L logic voltage) outputted by the buffer circuit 34. According to this arrangement, the capacitance of the variable capacitance diode 38 changes according to the jitter control voltage, due to application of the reverse voltage between the anode-cathode thereof.

Alternatively, the cathode of the variable capacitance diode 38 may be connected towards the output terminal of the jitter control section 32, and the anode of the variable capacitance diode 38 may be connected towards the connection point 50. In this case, the jitter control section 32 outputs a jitter control voltage in the range higher than the highest voltage (the higher one of the H logic voltage and the L logic voltage) outputted by the buffer circuit 34. According to this arrangement, the capacitance of the variable capacitance diode 38 changes according to the jitter control voltage, due to application of the reverse voltage between the anode-cathode thereof.

Here, note that it is preferable that the jitter control section 32 outputs such a jitter control voltage that is able to provide the variable capacitance diode 38 with a reverse voltage sufficiently larger than the potential difference between the H logic voltage and the L logic voltage. By arranging in such a way, the jitter control section 32 will be able to decrease the fluctuation of the capacitance of the variable capacitance diode 38 that is dependent to the fluctuation of the logic of the signal propagating on the signal transmission path 30.

In the case where the anode of the variable capacitance diode 38 is connected towards the output terminal of the jitter control section 32 and the cathode of the variable capacitance diode 38 is connected towards the connection point 50, the buffer circuit 34 may output 1.3V+200 mV as the H logic voltage and 1.3V−200 mV as the L logic voltage, as an example. In this case, as an example, the jitter control section 32 may output a jitter control voltage that fluctuates in the range of ±2V with −1.3V as the center voltage. According to this arrangement, the jitter control section 32 is able to apply a reverse voltage between the anode-cathode of the variable capacitance diode 38. Furthermore, the jitter control section 32 can also provide the variable capacitance diode 38 with a reverse voltage sufficiently larger than the potential difference between the H logic voltage and the L logic voltage.

In addition, when the connection point 50 is viewed from the output terminal of the jitter control section 32, the serial resistance 36 and the variable capacitance diode 38 function as a high pass filter. Accordingly, it is preferable that the jitter control section 32 outputs a jitter control voltage that fluctuates in a frequency sufficiently lower than the frequency of a signal propagating on the signal transmission path 30. Accordingly, the jitter control section 32 will be able to eliminate a noise that would be added to a signal propagating on the signal transmission path 30 attributable to the effect of the fluctuation of the jitter control voltage, by means of the high pass filter configured by the serial resistance 36 and the variable capacitance diode 38. For example, when a signal having several GHz is propagated on the signal transmission path 30, the jitter control section 32 may output a jitter control voltage that fluctuates in the frequency of several tens of MHz, as an example. Such a jitter applying circuit 20 is able to apply jitter to a signal inputted to the input end 52, with a simple configuration and with favorable accuracy.

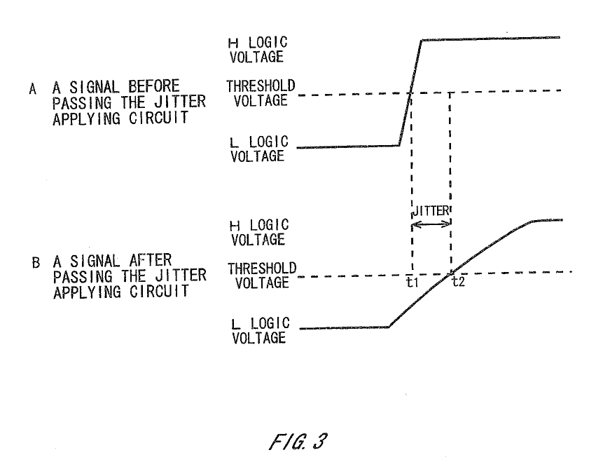

FIG. 3 shows one example of a signal before passing the jitter applying circuit 20 and a signal after passing the jitter applying circuit 20. The jitter applying circuit 20 is supplied with a signal having a waveform whose logic is switched in a predetermined direction (e.g. a waveform switching from the L logic voltage to the H logic voltage, or a waveform switching from the H logic voltage to the L logic voltage) at an arbitrary time t1, as shown as “A” in FIG. 3. That is, the jitter applying circuit 20 is supplied with a signal that has a waveform that becomes the threshold voltage (V_{TH}) at the time t1.

In such a case, the jitter applying circuit 20 outputs a waveform which is rendered more blunt than the supplied waveform. As a result, the jitter applying circuit 20 is able to output a signal having a waveform whose logic is switched in a predetermined direction (e.g. a waveform switching from the L logic voltage to the H logic voltage, or a waveform switching from the H logic voltage to the L logic voltage) at the time t2 delayed from the time t1 by the amount corresponding to the jitter to be applied, as shown as B in FIG. 3. That is, the jitter applying circuit 20 is able to output a signal that has a waveform that becomes the threshold voltage (V_{TH}) at the time t2.

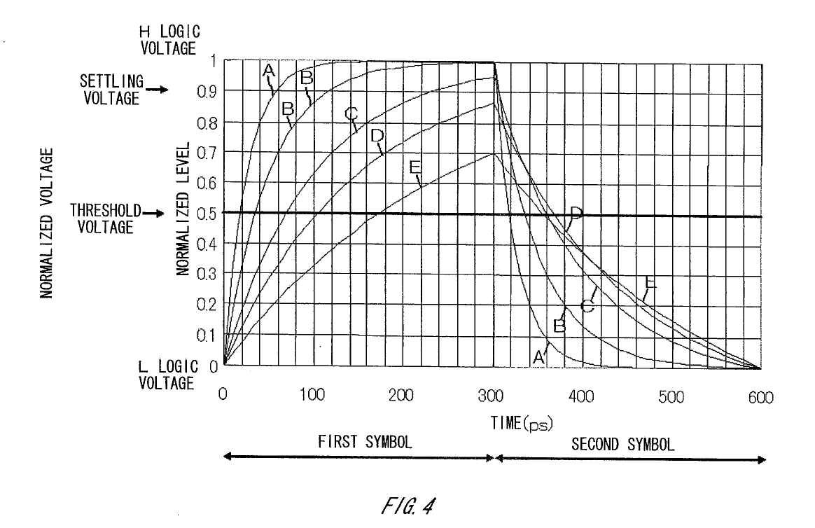

FIG. 4 shows one example of a waveform of a signal having passed the jitter applying circuit 20, in the case where the capacitance of the variable capacitance diode 38 is changed. The variable capacitance diode 38 is able to create a more blunt waveform for a signal outputted from the buffer circuit 34, as the capacitance becomes larger. That is, the variable capacitance diode 38 is able to delay a signal by a greater amount as the capacitance becomes larger.

“A” in FIG. 4 represents a waveform when the serial resistance 36 is 50Ω and the variable capacitance diode 38 is 0.5 pF. “B” in FIG. 4 represents a waveform when the serial resistance 36 is 50Ω and the variable capacitance diode 38 is 1 pF. “C” in FIG. 4 represents a waveform when the serial resistance 36 is 50Ω and the variable capacitance diode 38 is 2 pF.

“D” in FIG. 4 represents a waveform when the serial resistance 36 is 50Ω and the variable capacitance diode 38 is 3 pF. “E” in FIG. 4 represents a waveform when the serial resistance 36 is 50Ω and the variable capacitance diode 38 is 5 pF.

In a period of one cycle shown by the first symbol in FIG. 4, the jitter control section 32 is able to delay a signal by a greater amount, by controlling the variable capacitance diode 38 to increase such as by “0.5 pF, 1 pF, 2 pF, 3 pF, and 5 pF”. That is, the jitter control section 32 is able to apply larger jitter to a signal by controlling the variable capacitance diode 38 to be larger.

In addition, in a period of one cycle shown by the first symbol in FIG. 4, when the variable capacitance diode 38 is smaller than or equal to 2 pF (“A” “B” “C” in FIG. 4), the signal is settled. As opposed to this, in the first symbol in FIG. 4, when the variable capacitance diode 38 is larger than or equal to 3 pF (“E” “F” in FIG. 4), the signal is not settled.

Here, the situation where the signal is settled corresponds to a case where, if a signal changes from the L logic voltage to the H logic voltage, the voltage of the signal has reached a predetermined error range from the H logic voltage (i.e. within 0-10% of the potential difference between the L logic voltage and the H logic voltage, for example). In addition, if a signal changes from the H logic voltage to the L logic voltage, the situation where the signal is settled corresponds to a case where the voltage of the signal has reached a predetermined error range from the L logic voltage.

Whether the signal is settled or not is determined by the length of the signal pattern, the potential difference between the L logic voltage and the H logic voltage, the resistance value of the serial resistance 36, and the capacitance of the variable capacitance diode 38. Accordingly, the jitter control section 32 is able to control whether to settle the signal within one symbol period of a signal, by controlling the capacitance of the variable capacitance diode 38.

Here, when applying periodic jitter, the jitter control section 32 has to apply jitter having a value designated for each symbol, regardless of the pattern of the signal propagating on the signal transmission path 30. However, when a signal is not settled in one of a plurality of continuous symbols, the time required for the signal to reach the threshold voltage V_{TH} from the symbol starting point, in the next symbol to the symbol in which the signal is not settled, will be faster than for the other symbols. For example in “E” in FIG. 4, the time required for a signal to reach the threshold voltage V_{TH} from the symbol starting point is about 170 p seconds in the first symbol, and 55 p seconds in the second symbol. As can be seen from this example, the next symbol (the second symbol) to the symbol in which the signal is not settled will be faster than the other symbols (e.g. the first symbol).

In view of this, as an example, when applying periodic jitter to a signal propagating on the signal transmission path 30, the jitter control section 32 may output a jitter control voltage for generating the capacitance of the variable capacitance diode 38 that is smaller than or equal to the upper-limit capacitance capable of settling the signal within one cycle of the signal. As a result, the jitter control section 32 is able to settle all the symbols, and so it becomes possible to correctly apply jitter of a designated value to all the symbols. Therefore, the jitter control section 32 is able to apply periodic jitter to a signal propagating on the signal transmission path 30 with accuracy.

As opposed to this, the data dependent jitter is jitter whose settling property changes according to a signal that passes through the transmission line. In view of this, the jitter control section 32 may output a jitter control voltage that renders the capacitance of the variable capacitance diode 38 to be a capacitance that exceeds the upper-limit capacitance capable of settling the signal in the signal cycle, when applying data dependent jitter to a signal propagating on the signal transmission path 30, as an example. As a result, the jitter control section 32 is able to change the settling property according to a signal propagating on the signal transmission path 30. Therefore, the jitter control section 32 is able to apply data dependent jitter to the signal with accuracy.

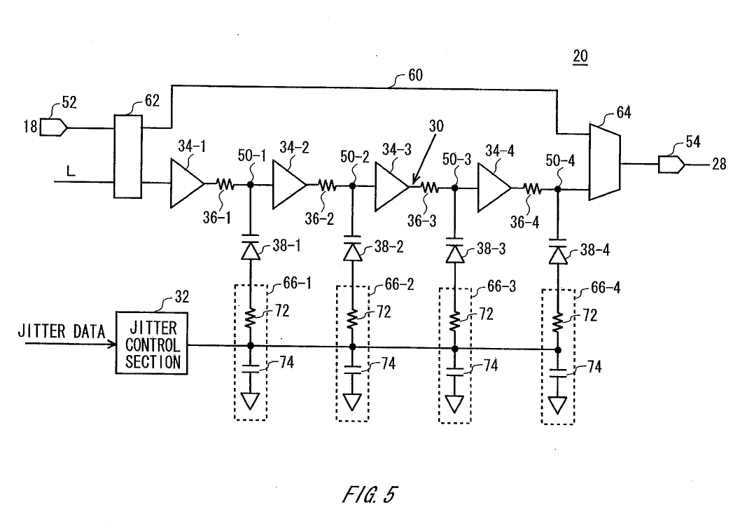

FIG. 5 shows a configuration of a jitter applying circuit 20 according to a first modification example of the present embodiment. The jitter applying circuit 20 according to the present modification example adopts substantially the same configuration and function as those of the jitter applying circuit 20 according to the present embodiment shown in FIG. 2, and so the members having substantially the same configuration and function as the members included in the jitter applying circuit 20 shown in FIG. 2 are assigned the same reference numerals, and only the differences therebetween are described as follows.

The jitter applying circuit 20 according to the present modification example includes a signal transmission path 30, a jitter control section 32, a plurality of buffer circuits 34, a plurality of serial resistances 36, a plurality of variable capacitance diodes 38, a bypass transmission path 60, an input-side selecting section 62, an output-side selecting section 64, and a plurality of noise eliminating sections 66. In the present modification example, the signal transmission path 30 includes a plurality of connection points 50 (e.g. connection points 50-1-50-4).

The plurality of buffer circuits 34 (e.g. the buffer circuits 34-1-34-4) are provided to correspond to the plurality of connection points 50 respectively. Each of the plurality of buffer circuits 34 is serially connected on the signal transmission path 30 to be closer to the input end 52 than a corresponding connection point 50, and that to be closer to the output end 54 than another connection point 50 that is aligned closer to the input end 52 than the corresponding connection point 50.

That is, the first buffer circuit 34-1 is provided between the input end 52 and the first connection point 50-1. The second buffer circuit 34-2 is provided between the first connection point 50-1 and the second connection point 50-2. The mth buffer circuit 34-m is provided between the (m-1)th connection point 50-(m-1) and the mth connection point 50-m.

The plurality of serial resistances 36 (e.g. serial resistances 36-1-36-4) are provided to correspond to the plurality of connection points 50 respectively. Each of the plurality of serial resistances 36 is serially connected between a corresponding buffer circuit 34 and a corresponding connection point 50 on the signal transmission path 30.

That is, one end of the first serial resistance 36-1 is connected to an output terminal of the first buffer circuit 34- 1, and the other end thereof is connected to the first connection point 50-1. One end of the second serial resistance 36-2 is connected to an output terminal of the second buffer circuit 34-2, and the other end thereof is connected to the second connection point 50-2. Then, the mth serial resistance 36-2 is connected to an output terminal of the mth buffer circuit 34-m, and the other end thereof is connected to the mth connection point 50-m.

The plurality of variable capacitance diodes 38 (e.g. variable capacitance diodes 38-1-38-4) are provided to correspond to the plurality of connection points 50 on the signal transmission path 30, respectively. Each of the plurality of variable capacitance diodes 38 is provided between a corresponding connection point 50 and an output terminal of the jitter control section 32. Then, the capacitance of each of the plurality of variable capacitance diodes 38 changes according to the jitter control voltage outputted from the jitter control section 32.

The jitter applying circuit 20 according to the present modification example includes a plurality of sets of buffer circuit 34, serial resistance 36, and variable capacitance diode 38. Each of the plurality of sets of buffer circuit 34, serial resistance 36, and variable capacitance diode 38, which correspond to the plurality of connection points 50 respectively, functions as a variable delay circuit for delaying a logic switching time for a supplied signal (i.e. a time at which the signal becomes the threshold voltage V_{TH}). That is, the plurality of sets of buffer circuit 34, serial resistance 36, and variable capacitance diode 38 function as a plurality of variable delay circuits serially connected on the signal transmission path 30. As a result, according to the jitter applying circuit 20 according to the present modification example as explained above, it becomes possible to apply larger jitter to a signal inputted to the input end 52.

The bypass transmission path 60 transmits a signal from the input end 52 to the output end 54. The bypass transmission path 60 may have a predetermined delay amount as an example.

The input-side selecting section 62 selects which one of the signal transmission path 30 and the bypass transmission path 60 the signal inputted via the input end 52 should pass before being outputted. The output-side selecting section 64 selects one of the signal having passed the signal transmission path 30 and the signal having passed the bypass transmission path 60, and outputs the selected signal to outside via the output end 54. The output-side selecting section 64 selects one of the signal having passed the signal transmission path 30 and the signal having passed the bypass transmission path 60 by synchronizing the selection of the input-side selecting section 62. According to the jitter applying circuit 20 according to the present modification example stated above, when not applying jitter, it is possible to output, to the output end 54, a signal inputted via the input end 52 without passing the signal to the buffer circuit 34, the serial resistance 36, and the variable capacitance diode 38, which are for applying jitter.

In addition, as an example, in passing an input signal by one of the signal transmission path 30 and the bypass transmission path 60, the input-side selecting section 62 may input a predetermined signal value (e.g. the L logic voltage, the H logic voltage, and the ground voltage) to the other of the signal transmission path 30 and the bypass transmission path 60. As a result, the input-side selecting section 62 may restrain a noise from occurring, by maintaining the potential of either of the signal transmission path 30 and the bypass transmission path 60 that is not passing the signal, to be constant.

Furthermore, as an example, when not passing a signal to the signal transmission path 30 and the bypass transmission path 60, the input-side selecting section 62 may input a predetermined signal value to both of the signal transmission path 30 and the bypass transmission path 60. As a result, when not passing a signal to the signal transmission path 30 and the bypass transmission path 60, the input-side selecting section 62 is able to restrain a noise from occurring, by maintaining the potential for both of the signal transmission path 30 and the bypass transmission path 60, to be constant.

The plurality of noise eliminating sections 66 are provided to correspond to the plurality of variable capacitance diodes 38 respectively. Then, each of the plurality of noise eliminating sections 66 eliminates a noise occurring at the output terminal side of the jitter control section 32, by passing of a signal propagating on the signal transmission path 30 through each variable capacitance diode 38.

That is, the variable capacitance diode 38 passes a high frequency component of a signal propagating on the signal transmission path 30 towards the output terminal of the jitter control section 32. Each of the plurality of noise eliminating sections 66 flows a high frequency component passed by a corresponding variable capacitance diode 38, to a ground for example. By this arrangement, according to the jitter applying circuit 20 according to the present modification example, it is possible to apply jitter with accuracy, since it becomes possible to eliminate a high frequency signal having passed the variable capacitance diode 38 by not substantially propagating to the other circuits (e.g. the other variable capacitance diodes 38).

Each of the plurality of noise eliminating sections 66 may include a noise eliminating resistance 72 and a noise eliminating capacitor 74, as an example. The noise eliminating resistance 72 is connected between a corresponding variable capacitance diode 38 and an output terminal of the jitter control section 32. The noise eliminating capacitor 74 is connected between the output terminal of the jitter control section 32 and the reference potential (e.g. ground). The noise eliminating section 66 stated above functions as a low pass filter. That is, the noise eliminating section 66 is able to function as a low pass filter for eliminating a noise occurring attributable to the effect of the high frequency component passed through the variable capacitance diode 38.

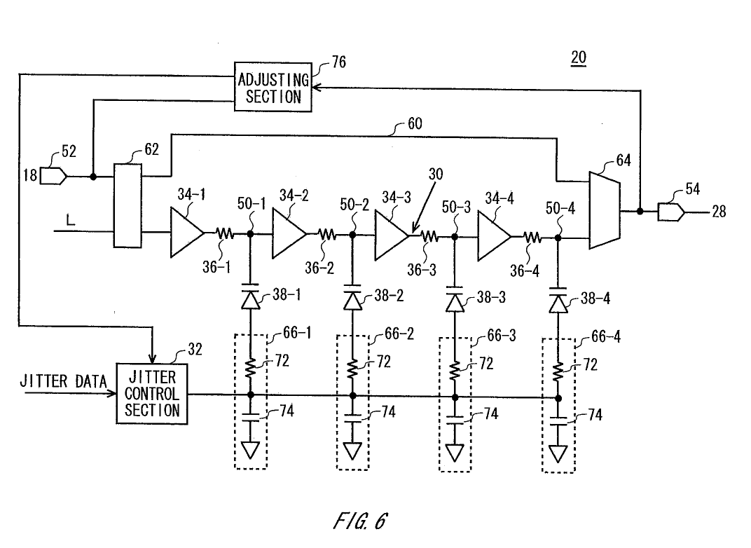

FIG. 6 shows a configuration of a jitter applying circuit 20 according to a second modification example of the present embodiment. The jitter applying circuit 20 according to the present modification example adopts substantially the same configuration and function as those of the jitter applying circuit 20 according to the first modification example shown in FIG. 5, and so the members having substantially the same configuration and function as the members included in the jitter applying circuit 20 shown in FIG. 5 are assigned the same reference numerals, and only the differences therebetween are described as follows.

The jitter applying circuit 20 according to the present modification example further includes an adjusting section 76. The adjusting section 76 sets a reference voltage of a jitter control voltage, based on a difference between a timing generated when passing a signal having a predetermined timing to the signal transmission path 30 and a timing generated when passing a signal having a predetermined timing to the bypath transmission path 60. Here, the reference voltage of the jitter control voltage means a voltage that is able to supply timing jitter (e.g. 0 jitter) that functions as a reference.

As an example, in the first step, the adjusting section 76 passes a signal having a predetermined timing to the bypass transmission path 60, and measures the timing at which the signal after having passed through the bypass transmission path 60 is acquired. Next, in the second step, the adjusting section 76 generates a predetermined jitter control voltage from the jitter control section 32, passes the signal having the predetermined timing through the signal transmission path 30, and measures the timing at which the signal after having passed through the signal transmission path 30 is acquired. Next, the adjusting section 76 calculates the reference voltage of the jitter control voltage, using the timing difference between the acquiring timing measured in the first step and the acquiring timing measured in the second step, and the jitter control voltage given in the second step. Then the adjusting section 76 may set the calculated reference voltage of the jitter control voltage, to the jitter control section 32.

Furthermore, the adjusting section 76 may repetitively execute the second step by sequentially changing the jitter control voltage. According to this arrangement, the adjusting section 76 is able to set a relation between each jitter amount and a corresponding jitter control voltage, to the jitter control section 32.

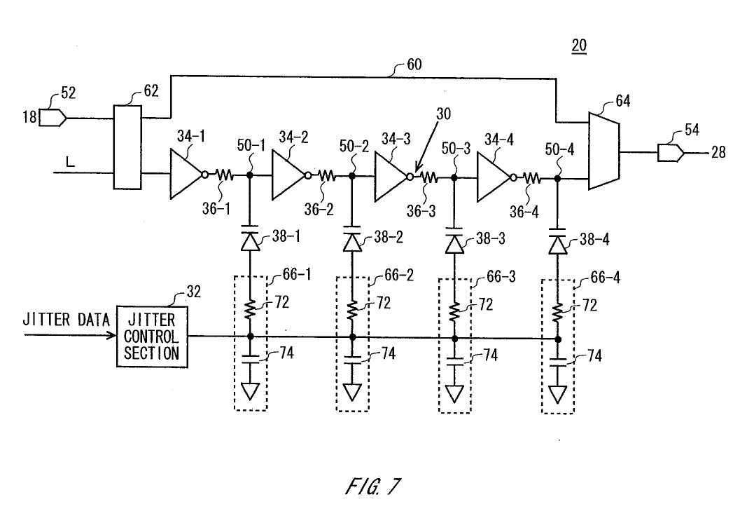

FIG. 7 shows a configuration of a jitter applying circuit 20 according to a third modification example of the present embodiment. The jitter applying circuit 20 according to the present modification example adopts substantially the same configuration and function as those of the jitter applying circuit 20 according to the first modification example shown in FIG. 5, and so the members having substantially the same configuration and function as the members included in the jitter applying circuit 20 shown in FIG. 5 are assigned the same reference numerals, and only the differences therebetween are described as follows.

Each of the plurality of buffer circuits 34 according to the present modification example is an inversion buffer. That is, in the present modification example, each of the plurality of buffer circuits 34 outputs the L logic voltage when the voltage of a received signal is larger than or equal to a threshold voltage V_{TH}. In addition, in the present modification example, the driver circuit 28 outputs the H logic voltage when the voltage of the received signal is smaller than the threshold voltage V_{TH}.

Furthermore, as an example, the jitter applying circuit 20 may include an even number of buffer circuits 34. According to this arrangement, the jitter applying circuit 20 is able to equalize the logic of the signal inputted from the input end 52 to the logic of the signal outputted from the output end 54. Furthermore, such a jitter applying circuit 20 is able to eliminate the error occurring due to the difference between the leading and the trailing of a signal.

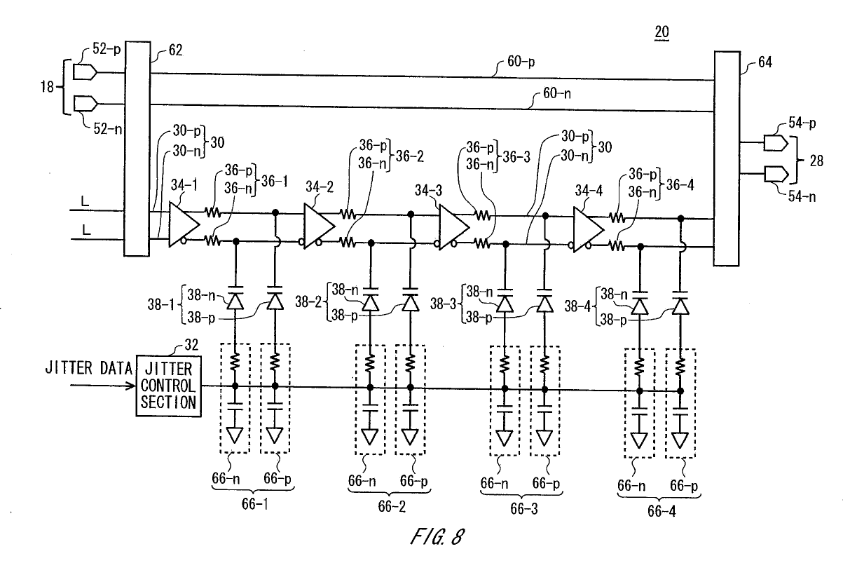

FIG. 8 shows a configuration of a jitter applying circuit 20 according to a fourth modification example of the present embodiment. The jitter applying circuit 20 according to the present modification example adopts substantially the same configuration and function as those of the jitter applying circuit 20 according to the first modification example shown in FIG. 5, and so the members having substantially the same configuration and function as the members included in the jitter applying circuit 20 shown in FIG. 5 are assigned the same reference numerals, and only the differences therebetween are described as follows.

The jitter applying circuit 20 according to the present modification example receives a differential signal outputted from the pattern generator 18, via the input end 52 (i.e. the positive-side input end 52-p and the negative-side input end 52-n). Then the jitter applying circuit 20 supplies a signal to which jitter is applied, to the driver circuit 28 via the output end 54 (i.e. the positive-side output end 54-p and the negative-side output end 54-n).

The signal transmission path 30 includes a positive-side signal transmission path 30-p and a negative-side signal transmission path 30-n. The positive-side signal transmission path 30-p transmits a positive-side signal of a differential signal. The negative-side signal transmission path 30-n transmits a negative-side signal of a differential signal.

Each of the plurality of buffer circuits 34 is a differential buffer. That is, the buffer circuit 34 outputs a positive-side signal of the H logic voltage from the positive-side output terminal and outputs a negative-side signal of the L logic voltage from the negative-side output terminal, when the difference between the positive-side signal and the negative-side signal of the received differential signal is larger than or equal to 0. In addition, the buffer circuit 34 outputs a positive-side signal of the L logic voltage from the positive-side output terminal and outputs a negative-side signal of the H logic voltage from the negative-side output terminal, when the difference between the positive-side signal and the negative-side signal of the received differential signal is smaller than 0.

Each of the plurality of serial resistances 36 includes a positive-side serial resistance 36-p and a negative-side serial resistance 36-n. The positive-side serial resistance 36-p is provided on the positive-side signal transmission path 30-p. The negative-side serial resistance 36-n is provided on the negative-side signal transmission path 30-n.

Each of the plurality of variable capacitance diodes 38 includes a positive-side variable capacitance diode 38-p and a negative-side variable capacitance diode 38-n. The positive-side variable capacitance diode 38-p is provided between the connection point 50 on the positive-side signal transmission path 30-p and the output terminal of the jitter control section 32. The negative-side variable capacitance diode 38-n is provided between the connection point 50 on the negative-side signal transmission path 30-n and the output terminal of the jitter control section 32.

The bypass transmission path 60 includes a positive-side bypass transmission path 60-p and a negative-side bypass transmission path 60-n. The positive-side bypass transmission path 60-p transmits a positive-side signal of a differential signal. The negative-side bypass transmission path 60-n transmits a negative-side signal of a differential signal.

Each of the plurality of noise eliminating sections 66 includes a positive-side noise eliminating section 66-p and a negative-side noise eliminating section 66-n. The positive-side noise eliminating section 66-p is provided to correspond to the positive-side variable capacitance diode 38-p. The negative-side noise eliminating section 66-n is provided to correspond to the negative-side variable capacitance diode 38-n.

In the present modification example, a plurality of sets of positive-side buffer circuit 34-p, positive-side serial resistance 36-p, positive-side variable capacitance diode 38-p, negative-side buffer circuit 34-n, negative-side serial resistance 36-n, and negative-side variable capacitance diode 38-n function as a plurality of differential variable delay circuits serially connected on the signal transmission path 30. As a result, according to the jitter applying circuit 20 according to the present modification example as stated above, it is possible to apply jitter to a differential signal inputted to the input end 52. Furthermore, such a jitter applying circuit 20 is able to eliminate the error occurring due to the difference between the leading and the trailing of a signal. Still further, such a jitter applying circuit 20 is able to eliminate the noise occurring to the output terminal side of the jitter control section 32, since the noise leaking from the positive-side signal of a differential signal is offset by the noise leaking from the negative-side signal of the differential signal.

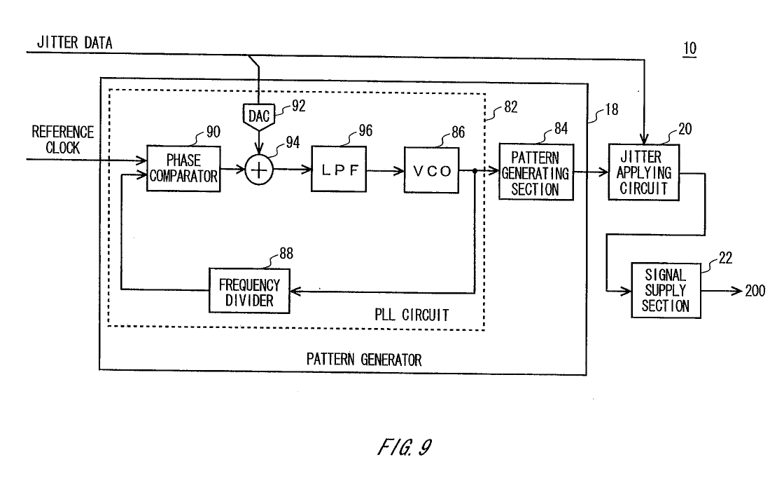

FIG. 9 shows a configuration of a test apparatus 10 according to a fifth modification example of the present embodiment. The test apparatus 10 according to the present modification example adopts substantially the same configuration and function as those of the test apparatus 10 according to the present embodiment shown in FIG. 1, and so the members having substantially the same configuration and function as the members included in the test apparatus 10 shown in FIG. 1 are assigned the same reference numerals, and only the differences therebetween are described as follows.

In the present modification example, a pattern generator 18 includes a PLL circuit 82 and a pattern generating section 84. The PLL circuit 82 generates a shift clock whose phase is shifted from a reference clock by a designated phase. The pattern generating section 84 generates a test pattern in synchronization with the shift clock.

Moreover, the PLL circuit 82 changes the phase shift amount according to the jitter data. As an example, the PLL circuit 82 may change the phase shift amount according to a low frequency component of the jitter data (the value of the higher-order bits of the jitter data). In this case, the jitter applying circuit 20 may add jitter to a signal according to a high frequency component of jitter data (e.g. the bit value excluding the higher-order bits values of the jitter data).

As an example, the PLL circuit 82 may include a VCO 86, a frequency divider 88, a phase comparator 90, a DAC 92, an adder 94, and an LPF 96. The VCO 86 outputs a signal having a frequency that is in accordance with a supplied control voltage. The frequency divider 88 outputs a frequency divided signal resulting from dividing the frequency of a signal outputted from the VCO 86 into 1/N (N is an integer).

The phase comparator 90 detects a phase difference between the reference clock and the frequency divided signal outputted from the frequency divider 88, and outputs a signal having a voltage that is in accordance with the detected phase difference. The DAC 92 outputs a signal having a voltage that is in accordance with supplied jitter data.

The adder 94 adds the voltage of the output signal of the phase comparator 90 and the voltage outputted from the DAC 92. The LPF 96 outputs a control voltage obtained by smoothing the voltage outputted from the adder 94, to supply the control voltage to the VCO 86.

Then, such a PLL circuit 82 outputs the signal outputted from the VCO 86 as a shift clock. Such a PLL circuit 82 is able to shift the phase of the shift clock according to the jitter data.

Such a test apparatus 10 is able to add jitter to a test pattern, by controlling both of the pattern generator 18 and the jitter applying circuit 20. Accordingly, the test apparatus 10 is able to apply jitter having a relatively low frequency by means of the pattern generator 18, and to apply jitter having a relatively high frequency by means of the jitter applying circuit 20, for example. According to the test apparatus 10, it becomes possible to apply jitter in a wide range to a test pattern, because the test apparatus 10 is able to apply 2 kinds of jitters in the described manner.

Although some aspects of the present invention have been described by way of exemplary embodiments, it should be understood that those skilled in the art might make many changes and substitutions without departing from the spirit and the scope of the present invention which is defined only by the appended claims.

What is claimed is:

1. A jitter applying circuit comprising:
a signal transmission path that transmits a signal from an input end to an output end thereof;
a jitter control section that outputs, from an output terminal thereof, a jitter control voltage that is in accordance with jitter to be superposed to a signal propagating on the signal transmission path; and
a variable capacitance diode that is provided between a connection point on the signal transmission path and the output terminal of the jitter control section, and whose capacitance changes in accordance with the jitter control voltage.

2. The jitter applying circuit as set forth in claim 1, further comprising:
a buffer circuit that is serially connected closer to the input end than the connection point is on the signal transmission path; and
a serial resistance that is serially connected between the buffer circuit and the connection point, on the signal transmission path.

3. The jitter applying circuit as set forth in claim 2, comprising:
a plurality of variable capacitance diodes provided to correspond to a plurality of connection points on the signal transmission path, each of the variable capacitance diodes being provided between a corresponding one of the connection points and the output terminal of the jitter control section;
a plurality of buffer circuits that are provided to correspond to the plurality of connection points respectively, each of the buffer circuits being serially connected on the signal transmission path to be closer to the input end than a corresponding connection point, and that to be closer to the output end than another of the connection points that is aligned closer to the input end than the corresponding connection point; and
a plurality of serial resistances that are provided to correspond to the plurality of connection points respectively, each of the serial resistances being serially connected between a corresponding buffer circuit and a corresponding connection point on the signal transmission path.

4. The jitter applying circuit as set forth in claim 3, further comprising:
a plurality of noise eliminating sections that are provided to correspond to the plurality of variable capacitance diodes respectively, each of the noise eliminating sections eliminating a noise occurring at the output terminal side of the jitter control section, by passing of a signal propagating on the signal transmission path through each of the variable capacitance diodes.

5. The jitter applying circuit as set forth in claim 4, wherein
each of the plurality of noise eliminating sections includes:
a noise eliminating resistance connected between a corresponding variable capacitance diode and the output terminal of the jitter control section; and
a noise eliminating capacitor connected between the output terminal and a reference potential.

6. The jitter applying circuit as set forth in claim 3, further comprising:
a selecting section that selects which one of the signal transmission path and a bypass transmission path that has a predetermined delay amount an input signal should pass before being outputted.

7. The jitter applying circuit as set forth in claim 6, wherein
in passing an input signal by one of the signal transmission path and the bypass transmission path, the selecting section inputs a predetermined signal value to the other of the signal transmission path and the bypass transmission path.

8. The jitter applying circuit as set forth in claim 6, further comprising:
an adjusting section that sets a reference voltage of the jitter control voltage, based on a difference between a timing generated when passing a signal having a predetermined timing to the signal transmission path and a timing generated when passing the signal having a predetermined timing to the bypath transmission path.

9. The jitter applying circuit as set forth in claim 3, wherein
each of the plurality of buffer circuits is an inversion buffer.

10. The jitter applying circuit as set forth in claim 3, wherein
when applying periodic jitter to the signal propagating on the signal transmission path, the jitter control section outputs the jitter control voltage for generating the capacitance of the variable capacitance diode that is smaller than or equal to an upper-limit capacitance capable of settling the signal within a cycle of the signal, and
when applying data dependent jitter to a signal propagating on the signal transmission path, the jitter control section outputs the jitter control voltage that renders the capacitance of the variable capacitance diode to be a capacitance that exceeds the upper-limit capacitance.

11. The jitter applying circuit as set forth in claim 1, comprising:
a positive-side signal transmission path that transmits a positive-side signal of a differential signal;
a negative-side signal transmission path that transmits a negative-side signal of the differential signal;
a positive-side variable capacitance diode that is provided between a connection point on the positive-side signal transmission path and the output terminal of the jitter control section; and
a negative-side variable capacitance diode that is provided between a connection point on the negative-side signal transmission path and the output terminal of the jitter control section.

12. A test apparatus for testing a device under test, the test apparatus comprising:
a pattern generator that generates a test pattern for testing the device under test;
a jitter applying circuit that applies jitter to the test pattern; and
a signal supply section that supplies a test signal that is in accordance with the test pattern to which the jitter has been applied, to the device under test, wherein
the jitter applying circuit includes:
a signal transmission path that transmits, from an input end to an output end thereof, the test pattern received from the pattern generator;
a jitter control section that outputs, from an output terminal thereof, a jitter control voltage that is in accordance with jitter to be superposed to the test pattern propagating on the signal transmission path; and
a variable capacitance diode that is provided between a connection point on the signal transmission path and the output terminal of the jitter control section, and whose capacitance changes in accordance with the jitter control voltage.

13. The test apparatus as set forth in claim 12, wherein
the pattern generator includes:
a PLL circuit that generates a shift clock whose phase is shifted from a reference clock by a designated phase; and
a pattern generating section that generates the test pattern in synchronization with the shift clock.
